(19) United States
(12) Patent Application Publication
(10) Pub. No.: US 2021/0125285 A1
(43) Pub. Date: Apr. 29, 2021

(54) METHOD, DEVICE, STORAGE MEDIUM AND TERMINAL FOR MODIFYING ACCOUNT NAME

(71) Applicant: Ping An Technology (Shenzhen) Co., Ltd., Shenzhen, Guangdong (CN)

(72) Inventors: Shengsheng Li, Shenzhen, Guangdong (CN); Xiaoyu Zhu, Shenzhen, Guangdong (CN)

(73) Assignee: Ping An Technology (Shenzhen) Co., Ltd., Shenzhen, Guangdong (CN)

(21) Appl. No.: 16/092,760

(22) PCT Filed: Feb. 27, 2018
(86) PCT No.: PCT/CN2018/077351

§ 371 Date: Oct. 11, 2018

(30) Foreign Application Priority Data
Aug. 28, 2017 (CN) 201710747849.9

(51) Int. Cl. G06Q 40/08

(52) U.S. Cl. CPC G06Q 40/08

(57) ABSTRACT

Provided are a method, a device, a storage medium, and a terminal for modifying account name, comprising: generating an account name modification request and calling a first modification interface to send the modification request to a server upon the condition that the case status information is that the self-service claim settlement is under review; receiving the modification request through the first modification interface and modifying the account name of the self-service claim settlement according to the request; calling a second modification interface to send the modification request to the server upon the condition that the case status information is that the self-service claim settlement is in a settled state and the transfer for the self-service claim settlement fails due to incorrect account information; receiving the modification request through the second modification interface and modifying the account name of the self-service claim settlement, re-initiating the transfer for the self-service claim settlement.

This patent application is based on the Chinese invention patent application with the application number of 201710747849.9 filed on Aug. 28, 2017 and entitled “METHOD, DEVICE, STORAGE MEDIUM AND TERMINAL FOR MODIFYING ACCOUNT NAME”, and claims priority thereof.

### TECHNICAL FIELD

The present application is related to the field of communications technologies, and in particular, to a method, a device, a storage medium, and a terminal for modifying an account name.

### BACKGROUND

The insurance finance APP is an application for individual customers that integrate insurance protection, investment and wealth management, and health management. It is designed to provide one-stop financial product group purchase services and facilitate social life services for individual customers. Applicants can complete self-service claim settlement operations on the insurance financial APP. The so-called self-service claim settlement refers to the act that the applicant initiates the insurance claim to the insurance company through the insurance financial APP on the mobile terminal after an accident. Under normal circumstances, the mobile terminal may be an iPhone or a smartphone with Android system. Since the account information of the self-service claim settlement case is input by the applicant, when the applicant inputs an error, such as a wrong account name for the transfer, the transfer will fail, and the self-service claim settlement cannot be completed. However, the account information of the self-service claim settlement case is not allowed to be modified by the agency personnel, and the application program only allows the applicant to view the account name. In the case of incorrect input account name, a request can be submitted to the leader for approval only in the form of paper reporting, and the account name can be modified by a background administrator after the approval is passed. The applicant cannot modify the account name on his own, and the modification process is complicated.

### SUMMARY

The embodiments of the present application provide a method, a device, a storage medium, and a terminal for modifying an account name, so as to solve the problem that the prior art does not support the applicant to modify the account name on his own when a self-service claim settlement is performed on the mobile terminal, and improve the security of modifying the account name.

In a first aspect, a method for modifying an account name is provided, the method for modifying comprises:

in a process of a self-service claim settlement, generating an account name modification request according to a modified account name, and acquiring a case status information corresponding to the self-service claim settlement, by the mobile terminal;

calling a first modification interface to send the account name modification request to a server by the mobile terminal upon the condition that the case status information is that the self-service claim settlement is under review;

receiving the account name modification request through the first modification interface and modifying the account name of the self-service claim settlement according to the account name modification request by the server, so as to prepare for a claim settlement transfer;

calling a second modification interface to send the account name modification request to the server by the mobile terminal upon the condition that the case status information is that the self-service claim settlement is in a settled state and the transfer for the self-service claim settlement fails due to incorrect account information; and

receiving the account name modification request through the second modification interface, modifying the account name of the self-service claim settlement according to the account name modification request, and re-initiating the transfer for the self-service claim settlement, by the server.

Furthermore, the account name modification request further comprises an account number and an opening bank name input by an applicant.

After the server receives the account name modification request through the first modification interface or the server receives the account name modification request through the second modification interface, the method for modifying further comprises:

verifying the account number and the opening bank name in the account name modification request by the sever through a predetermined verification rule; and

acquiring an error type, and returning error information to the mobile terminal upon the condition that the verification fails.

Furthermore, a step of modifying the account name of the self-service claim settlement according to the account name modification request, so as to prepare for a claim settlement transfer comprises:

determining whether the modified account name is a third-party account name by the server, wherein the third-party account name is an account name of a third party other than the applicant or an associated insured of the applicant;

sending an upload prompt message to the mobile terminal to inform the applicant to upload an account authorization information by the sever upon the condition that the modified account name is the third-party account name; and

acquiring the account authorization information uploaded by the mobile terminal, triggering a verification process according to the account authorization information, and modifying an original account name to the third-party account name after a review for the account authorization information is passed, by the sever.

Furthermore, a step of modifying the account name of the self-service claim settlement according to the account name modification request, and re-initiating the transfer for the self-service claim settlement comprises:

determining whether the modified account name is a third-party account name by the server, wherein the third-party account name is an account name of a third party other than the applicant or an associated insured of the applicant;

generating an appeal request according to the account name modification request and sending the appeal request to a supervisor terminal by the server upon the condition that the modified account name is the third-party account name;

sending an upload prompt message to the mobile terminal by the server to notify the applicant to upload an account authorization information upon the condition that an appeal success message returned by the supervisor terminal according to the appeal request is received; and

acquiring the account authorization information uploaded by the mobile terminal, triggering a verification process according to the account authorization information, and modifying an original account name to the third-party account name after a review for the account authorization information is passed and initiating the transfer to the third party account name, by the sever.

In a second aspect, a device for modifying an account name is provided, the device for modifying comprises:

an acquiring module, configured to: in a process of a self-service claim settlement, generate an account name modification request according to a modified account name, and acquire case status information corresponding to the self-service claim settlement;

a first calling module configured to call a first modification interface to send the account name modification request to a server upon the condition that the case status information is that the self-service claim settlement is under review, such that the server modifies the account name of the self-service claim settlement according to the account name modification request, so as to prepare for a claim settlement transfer; and

a second calling module, configured to call a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiates the transfer for the self-service claim settlement.

In a third aspect, a device for modifying an account name is provided, the device for modifying comprises:

a first receiving module, configured to: in a process of a self-service claim settlement, receive an account name modification request sent by a mobile terminal through a first modification interface;

a first modifying module configured to modify the account name of the self-service claim settlement according to the account name modification request received by the first receiving module, so as to prepare for a claim settlement transfer;

a second receiving module, configured to receive the account name modification request sent by the mobile terminal through a second modification interface; and

a second modifying module, configured to modify the account name of the self-service claim settlement according to the account name modification request received by the second receiving module, and re-initiate the transfer for the self-service claim settlement.

Furthermore, the first modifying module comprises:

a first determining unit, configured to determine whether the modified account name is a third-party account name, wherein the third-party account name is an account name of a third party other than the applicant or an associated insured of the applicant;

a first uploading prompting unit, configured to send an upload prompt message to the mobile terminal to inform the applicant to upload an account authorization information upon the condition that the modified account name is the third-party account name; and

a first verifying and modifying unit, configured to acquire the account authorization information uploaded by the mobile terminal, trigger a verification process according to the account authorization information, and modify an original account name to the third-party account name after a review for the account authorization information is passed.

Furthermore, the second modifying module comprises:

a second determining unit, configured to determine whether the modified account name is a third-party account name, wherein the third-party account name is an account name of a third party other than the applicant or an associated insured of the applicant;

an appeal requesting unit, configured to generate an appeal request according to the account name modification request and send the appeal request to a supervisor terminal upon the condition that the modified account name is the third-party account name;

a second uploading prompting unit, configured to send an upload prompt message to the mobile terminal to notify the applicant to upload an account authorization information upon the condition that an appeal success message returned by the supervisor terminal according to the appeal request is received; and

a second verifying and modifying unit configured to acquire the account authorization information uploaded by the mobile terminal, trigger a verification process according to the account authorization information, and modify an original account name to the third-party account name after a review for the account authorization information is passed and initiate the transfer to the third party account name.

In a fourth aspect, a computer readable storage medium with computer readable instructions stored therein is provided, and when executed by a processor, the computer readable instructions implement the following steps of:

in a process of a self-service claim settlement, generating an account name modification request according to a modified account name, and acquiring a case status information corresponding to the self-service claim settlement;

calling a first modification interface to send the account name modification request to a server upon the condition that the case status information is that the self-service claim settlement is under review, such that the server modifies the account name of the self-service claim settlement according to the account name modification request, so as to prepare for a claim settlement transfer; and

calling a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiates the transfer for the self-service claim settlement.

In a fifth aspect, a computer readable storage medium with computer readable instructions stored therein is provided, and when executed by a processor, the computer readable instructions implement the following steps of:

in a process of a self-service claim settlement, receiving an account name modification request sent by the mobile terminal through a first modification interface;

modifying the account name of the self-service claim settlement according to the account name modification request received by the first modification interface, so as to prepare for a claim settlement transfer;

receiving the account name modification request sent by the mobile terminal through a second modification interface; and

modifying the account name of the self-service claim settlement according to the account name modification request received by the second modification interface, and re-initiating the transfer for the self-service claim settlement.

In a sixth aspect, the embodiments of the present application also provide a terminal, the terminal comprises a memory, a processor, and computer readable instructions stored in the memory and operable on the processor, when the processor executes the computer readable instructions, the following steps are implemented:

in a process of a self-service claim settlement, generating an account name modification request according to a modified account name, and acquiring a case status information corresponding to the self-service claim settlement;

calling a first modification interface to send the account name modification request to a server upon the condition that the case status information is that the self-service claim settlement is under review, such that the server modifies the account name of the self-service claim settlement according to the account name modification request, so as to prepare for a claim settlement transfer; and

calling a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiates the transfer for the self-service claim settlement.

In a seventh aspect, the embodiments of the present application also provide a terminal, the terminal comprises a memory, a processor, and computer readable instructions stored in the memory and operable on the processor, when the processor executes the computer readable instructions, the following steps are implemented:

in a process of a self-service claim settlement, receiving an account name modification request sent by the mobile terminal through a first modification interface;

modifying the account name of the self-service claim settlement according to the account name modification request received by the first modification interface, so as to prepare for a claim settlement transfer;

receiving the account name modification request sent by the mobile terminal through a second modification interface; and

modifying the account name of the self-service claim settlement according to the account name modification request received by the second modification interface, and re-initiating the transfer for the self-service claim settlement.

Compared with the prior art, the embodiments of the present application newly develops two modification interfaces to be called by the mobile terminal, such that the mobile terminal can support the modification of the account name in the self-service claim settlement; for the self-service claim settlement under review, the mobile terminal may call a first modification interface to send the account name modification request to a server on a claim system; the server receives the account name modification request through the first modification interface, and modifies the account name of the self-service claim settlement according to the account name modification request, so as to prepare for a claim settlement transfer; for the self-service claim settlement in a settled state, when the transfer for the self-service claim settlement fails due to incorrect account information, the mobile terminal may call a second modification interface to send the account name modification request to the server; and the server receives the account name modification request through the second modification interface, and modifies the account name of the self-service claim settlement, and re-initiates the transfer for the self-service claim settlement, thereby achieving that the applicant may modify the account name on his own and solving the problem that when the self-service claim settlement is performed on the mobile terminal, the existing technology may not support the applicant to modify the account name on his own and it is complicated to modify the account name, simplifying the original process of modifying the account name, and increasing the efficiency of the modification.

### BRIEF DESCRIPTION OF THE DRAWINGS

In order to more clearly explain the technical solutions in the embodiments of the present application, the drawings required in the description of the embodiments or the prior art will be briefly described in the follow. Obviously, the drawings in the following description are only embodiments of the present application. For those of ordinary skill in the art can also obtain other drawings based on these drawings without paying any creative effort.

FIG. 1 is a first implementation flowchart of a method for modifying an account name according to an embodiment of the present application;

FIG. 2 is a second implementation flowchart of a method for modifying an account name according to an embodiment of the present application;

FIG. 3 is a third implementation flowchart of a method for modifying an account name according to an embodiment of the present application;

FIG. 4 is a fourth implementation flowchart of a method for modifying an account name according to an embodiment of the present application;

FIG. 5 is a structure diagram of a device for modifying an account name according to an embodiment of the present application;

FIG. 6 is a structure diagram of a device for modifying an account name according to an embodiment of the present application;

FIG. 7 is a schematic diagram of a terminal according to an embodiment of the present application

### DETAILED DESCRIPTION

To make the objectives, technical solutions and advantages of the present application clearer, the present application will be further described hereafter with reference to the accompany drawings and embodiments. It shall be understood that, the embodiments described herein are only intended to illustrate but not to limit the present application.

When the self-service claim settlement is performed on a mobile terminal, the prior art only supports the modification of the bank account number and does not support the modification of the account name. In order to solve the above technical problem, the embodiment of the present application newly develops two modification interfaces on the claim system to be provided to the mobile terminal for calling, one modification interface is used to modify the self-service claim settlement case under review, and the other modification interface is used to modify the self-service claim settlement case in a settled state. The mobile terminal can call the above-mentioned modification interfaces through the ESG platform to interact with the claim system to complete the self-service modification of the account name Here, the ESG platform is an enterprise service management platform.

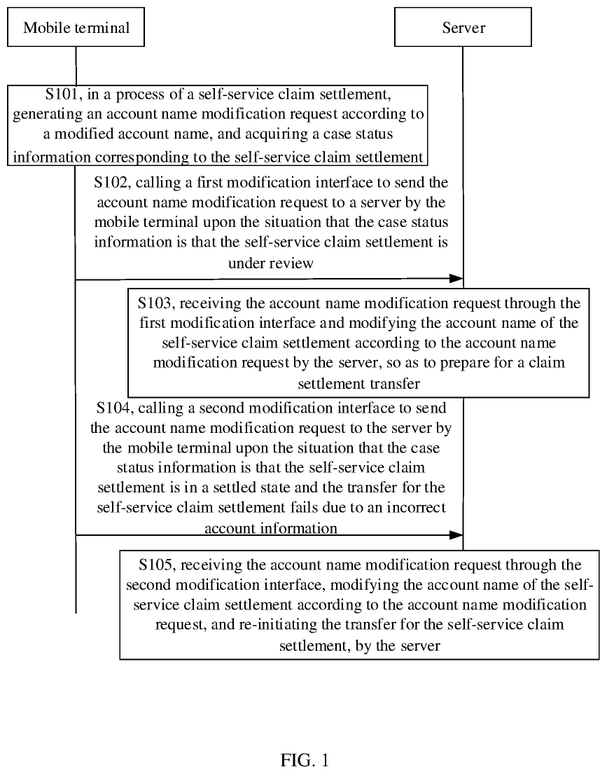

FIG. 1 shows a first implementation flowchart of a method for modifying an account name according to an embodiment of the present application. Referring to FIG. 1, the method for modifying comprises steps in the follow.

At step S101, in a process of a self-service claim settlement, the mobile terminal generates an account name modification request according to a modified account name, and acquires case status information corresponding to the self-service claim settlement.

In the embodiment of the present application, the applicant logins the insurance financing application program through the mobile terminal, clicks the account information modification function on the application program, and enters the account information modification interface. It should be understood that the applicant is a user who initiates the self-service claim settlement, and the account information is account basic information for receiving a claim settlement transfer, and comprises but is not limited to an account name, an opening bank name, an account number, etc. Therefore, the modification interface comprises but is not limited to the account name, the opening bank name, the account number and other fields that can be filled in. The mobile terminal receives the account name modified by the applicant through the modification interface and generates an account name modification request. Optionally, the modification request comprises but is not limited to the modified account name.

Then, the mobile terminal acquires case status information corresponding to this self-service claim settlement, to determine which interface is to be called for sending the account name modification request. Here, the case status information describes the current processing progress of the self-service claim settlement case which comprises: under review, settled, and indemnity paid. Wherein, under review indicates that the self-service claim settlement case is under investigation, analysis, or approval; settled indicates that the self-service claim settlement case has been processed or approved; and indemnity paid indicates that the bank has been commissioned to pay the indemnity and the indemnity will be transferred to the bank account in the near future. It can be seen that, under different case status, there is a corresponding processing flow for the self-service claim settlement case. Therefore, under different case status, the modification operations for the account name are also different.

At step S102, the mobile terminal calls a first modification interface to send the account name modification request to a server upon the condition that the case status information is that the self-service claim settlement is under review.

Herein, the embodiments of the present application newly develop two modification interfaces to be called by the mobile terminal and comprising a first modification interface and a second modification interface. For the self-service claim settlement case under different case status, different modification interface is used to match the processing flow for the present case status. Wherein, the first modification interface is used to modify the account name of the self-service claim settlement case under review; and the second modification interface is used to modify the account name of the self-service claim settlement case having been settled, and re-initiate the transfer after the modification is completed.

In the embodiment of the present application, the correspondences between different modification interfaces and the case statuses are recorded on the mobile terminal. Upon the condition that the case status information acquired at step S101 is that the self-service claim settlement is under review, the mobile terminal acquires and calls the first modification interface to send the modification request to the server of the claim system through querying the correspondence between the modification interface and the case status.

At step S103, the sever receives the account name modification request through the first modification interface, and modifies the account name of the self-service claim settlement according to the account name modification request, so as to prepare for a claim settlement transfer.

In the embodiment of the present application, the correspondences between different modification interfaces and the case statuses are also recorded on the mobile sever. Because the account name modification request is sent by the mobile terminal through calling the first modification interface, the server may receive the modification request through the first modification interface, and learn that the self-service claim settlement case corresponding to the account name modification request is under review through querying the correspondence. At this time, the server directly resolves the account name modification request to obtain the modified account name; and replaces an original account name with the modified account name and saves the modified account name. The modified account name will be used to complete subsequent investigations, analyses, or approvals.

Here, when the self-service claim settlement case is still under review, after the server of the claim system receives the account name modification request through the first modification interface, the server of the claim system may directly provide the account name modification request to the verifier for verification, and complete the update of the account name, to prepare for the claim settlement transfer. The above-mentioned steps of step S102 to step S103 achieve the modification of the account name for the self-service claim settlement case under review on the mobile terminal through the first modification interface, without the approval of the leader and the operation of the background administrator, thereby simplifying the original modification process of the account name and improving the efficiency of modification.

At step S104, the mobile terminal calls a second modification interface to send the account name modification request to the server upon the condition that the case status information is that the self-service claim settlement is in a settled state and the transfer for the self-service claim settlement fails due to incorrect account information.

Here, upon the condition that the case status information acquired at step S101 is that the self-service claim settlement is settled and there is a record shows that the transfer for the self-service claim settlement case fails due to incorrect account information, the mobile terminal calls the second modification interface to send the modification request to the server of the claim system through querying the correspondence between the modification interface and the case status.

At step S105, the sever receives the account name modification request through the second modification interface, modifies the account name of the self-service claim settlement according to the account name modification request, and re-initiates the transfer for the self-service claim settlement.

Here, since the modification request is sent by the mobile terminal through calling the second modification interface, it indicates that the self-service claim settlement corresponding to the modification request has been processed or the approved and there is a transfer failure record. The server may receive the modification request through the second modification interface, and learn that the settlement case corresponding to the modification request is in the settled state and there is a transfer failure record. At this time, the server resolves the modification request to obtain the modified account name; replaces the original account name with the modified account name and saves the modified account name; and re-initiates the transfer for the claim settlement based on the modified account name.

When the self-service claim settlement case has been settled and the transfer fails, the server of the claims system completes the update of the account name after receiving the account name modification request through the second modification interface, and simultaneously re-initiates the transfer, thereby prevent the applicant from re-initiating the transfer. The above-mentioned steps of step S104 to step S105 achieve the modification of the account name for the self-service claim settlement case having been settled on the mobile terminal through the second modification interface, without the approval of the leader and the operation of the background administrator, thereby simplifying the modification process of the original account name and improving the efficiency of modification.

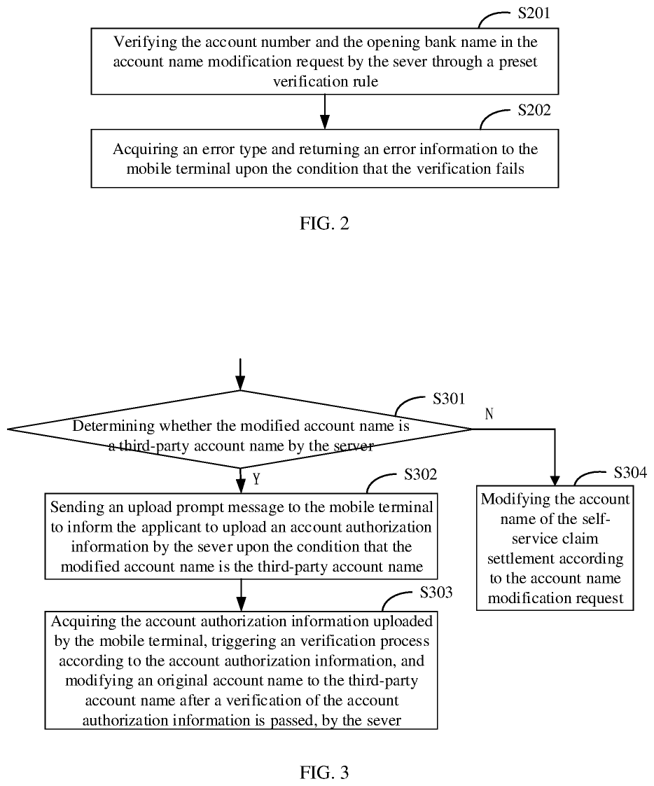

Optionally, as described above, at step S101, the account information modification interface also includes fields capable of being input such as an account number and an opening bank. Therefore, the account name modification request includes not only the modified account name but also the account number and the opening bank. Upon the condition that this information of the account number and the opening bank is incorrect when input, it will also result in that the account name modification and the claim settlement transfer cannot be completed. In order to solve the foregoing technical problem, on the basis of the first implementation flow of the method for modifying an account name provided in FIG. 1, a second implementation flow of a method for modifying an account name provided in the embodiment of the present application is presented, as shown in FIG. 2.

After the server receives the account name modification request through the first modification interface or the server receives the account name modification request through the second modification interface, a review for the modification request is added. The method for modifying further comprises steps in the follow.

At step S201, the sever verifies the account number and the opening bank name in the account name modification request by through a predetermined verification rule.

Here, the predetermined verification rule is related to the account number and the opening bank name, includes but is not limited to that: whether the string length of the account number satisfies the requirement, whether the string of the account number includes an illegal character, and whether the opening segment of the account number corresponds to the opening bank and whether the string of the opening bank includes an illegal character.

Exemplarily, the opening segments based on different bank accounts are different, for example, the opening segment of the ordinary card of the China Merchants Bank includes 621783, 622588, 622580, and 955550, and the server maintains the correspondence of the opening bank and the opening segment of the account number. Upon the condition that the opening segment of the account number is 621783, 622588, 622580 or 955550, it can be known that these opening segments correspond to the China Merchants Bank through the above correspondence, and further whether the opening bank in the account name modification request is China Merchants Bank is determined. If yes, the account number and the opening bank are correct is initially determined, the verification of the modification request is passed, and the server updates the account name of the self-service claim settlement according to the account name modification request. If no, the verification of the account number and the opening bank name fails is initially determined, that is, the information input by the applicant is incorrect, and step S202 is performed.

At step S202, an error type is acquired, and error information is returned to the mobile terminal.

In this embodiment of the present application, according to the verification rule that the account number and the opening bank name don't conform to, the corresponding error type is obtained, and an error prompt message is returned to the mobile terminal, thereby completing the verification of the account number and the opening bank, helping to improve the efficiency of the account name modification, and preventing the applicant from repeating the modification.

As described above, when the self-service claim settlement is in progress, the applicant may modify the account name to another third-party account name, that is, an account name of a third party other than the applicant or an associated insured of the applicant. These third-party account names have not been verified by the claim system, nor have been registered on the claim system, which presents certain security risks.

Optionally, in order to solve the foregoing technical problem that the third-party account name has a risk, for the self-service claim settlement case under review, on the basis of the first implementation flow of the method for modifying an account name provided in FIG. 1, the embodiment of the present application presents a third implementation flow of a method for modifying an account name provided in the embodiment of the present application, as shown in FIG. 3.

A step of modifying the account name of the self-service claim settlement according to the account name modification request, so as to prepare for a claim settlement transfer comprises the following steps.

At step S301, the server determines whether the modified account name is a third-party account name.

Here, the server has recorded the account name which is entered and registered when the applicant is purchasing the insurance. Therefore, the string content of the modified account name may be compared with the string content of the registered account name to determine whether the string content of the modified account name is the same as the string content of the registered account name. Alternatively, The equals( ) method of the string class in Java may be called to determine whether the two string contents are the same. Upon the condition that it is not the same, the modified account name input by the applicant is a third-party account name is determined, and step S302 is performed; and upon the condition that it is the same, the modified account name input by the applicant is the applicant and the associated insured of the applicant is determined, and step S304 modifying the account name of the self-service claim settlement according to the account name modification request, is performed.

At step S302, the sever sends an upload prompt message to the mobile terminal to inform the applicant to upload an account authorization information upon the condition that the modified account name is the third-party account name.

Upon the condition that the string content of the modified account name is different from the string content of the registered account name, it indicates that the modified account name input by the applicant is a third-party account name, and the server triggers a risk monitoring mechanism, sends an upload prompt message to the mobile terminal, such that the mobile terminal outputs a prompt message prompting the applicant to input the account authorization information according to the upload prompt message. The applicant completes the authorization operation according to the prompt message, the authorization operation includes but is not limited to reading the authorization confirmation on the mobile terminal, clicking the agree function identifier, uploading the electronic signature image, and so on.

At step S303, the sever acquires the account authorization information uploaded by the mobile terminal, triggers a verification process according to the account authorization information, and modifies an original account name to the third-party account name after a review for the account authorization information is passed.

Here, the account authorization information is image data, includes is but not limited to a policy, a request for change of an insurer, an electronic signature image, etc. Since the self-service claim settlement case is still under review, the account authorization information uploaded by the applicant may be directly transferred to the approver for checking. After receiving the account authorization information uploaded by the mobile terminal, the server triggers an email to notify the approver to check the account authorization information of the self-service claim settlement.

The approver may login a mailbox or a claim settlement management system through his terminal, after the account authorization information is checked, upon the condition that the approver accepts the third-party account name, the approver inputs a confirmation instruction, and the terminal generates an approval message according to the confirmation instruction, and sends the approval message to the server. Here, the approval message includes the third-party account name. The server modifies the original account name to the third-party account name according to the approval message, thereby completing the risk prevention and control of the account name modification when the self-service claim settlement is under review, further improving the security of the account name modification, which is beneficial to safeguard the rights of the claim applicant and the insurer.

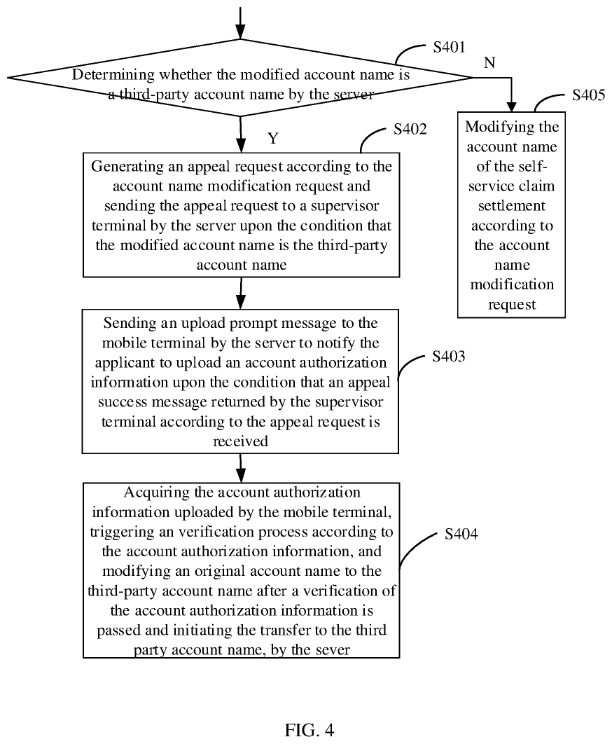

Optionally, in order to solve the foregoing technical problem that the third-party account name has a risk, for the settled self-service claim settlement case, on the basis of the first implementation flow of the method for modifying an account name provided in FIG. 1, the embodiment of the present application presents a fourth implementation flow of a method for modifying an account name provided in the embodiment of the present application, as shown in FIG. 4.

A step of modifying the account name of the self-service claim settlement according to the account name modification request, and re-initiating the transfer for the self-service claim settlement at step S105 comprises the following steps.

At step S401, the server determines whether the modified account name is a third-party account name.

Wherein, step S401 is the same as step S301 described in the embodiment of FIG. 3. Reference may be made to the description of the foregoing embodiment for detail which is not repeated here. Upon the condition that it is a third-party account name, step S402 is performed; otherwise, step S405 modifying the account name of the self-service claim settlement according to the account name modification request, is performed.

At step S402, the sever generates an appeal request according to the account name modification request and sends the appeal request to a supervisor terminal upon the condition that the modified account name is the third-party account name.

Here, for the settled claim settlement case, the verification and registration of the account number and the account name of the self-service claim settlement have been completed during the verifying stage. Upon the condition that the transfer fails due to an incorrect account name during the self-service claim settlement application, at this time upon the condition that the applicant changes the account name to a third-party account name, an appeal should be filed to the superior, the server generates an appeal request according to the account name modification request, and sends an appeal request message to the supervisor terminal.

At step S403, the sever sends an upload prompt message to the mobile terminal to notify the applicant to upload an account authorization information upon the condition that an appeal success message returned by the supervisor terminal according to the appeal request is received.

For the settled claim settlement case, the embodiment of the present application sends the appeal request message to the supervisory terminal, and the superior determines the risk of modifying the account name according to the appeal request message. After receiving the appeal request message, the supervisory terminal displays an appeal request interface to let a superior to assess the risk of modifying the account name modification of the current self-service claim settlement.

The appeal request interface includes an “agree” function identifier and a “disagree” function identifier. Upon the condition that the superior approves the modification of the account name and triggers the “agree” function identifier, the supervisory terminal returns an appeal success message to the server. At this time, the server sends an upload prompt message of the account authorization information to the mobile terminal to prompt the applicant to upload the account authorization information. Upon the condition that the superior consider that it needs to take risks and triggers the “disagree” function identifier, the supervisory terminal will return an appeal failure message to the server. At this time, the server terminates the process of modifying the account name without requiring the applicant to upload the account authorization information.

At step S404, the sever acquires the account authorization information uploaded by the mobile terminal, triggers a verification process according to the account authorization information, and modifies an original account name to the third-party account name after a review for the account authorization information is passed and initiates the transfer to the third party account name.

In the embodiment of the present application, the approver may login an mailbox or a claim settlement management system through his terminal, after the account authorization information is verified, upon the condition that the approver accepts the third-party account name, the approver inputs a confirmation instruction, and the terminal generates an approval message according to the confirmation instruction, and sends the approval message to the server. Here, the approval message includes the third-party account name and a transfer instruction. The server updates the original account name to the third-party account name according to the approval message, thereby realizing the risk prevention and control of modifying the account name of the settled self-service claim settlement case, thereby simplifying the modification process for the original account name, and improving the security of modifying the account name on the mobile terminal; and initiates a transfer to the third-party account name according to the transfer instruction to continue the last failed transfer operation.

It should be understood that, in the above embodiments, the sequence number of each step does not mean the order of execution, and the order of execution of each step should be determined by the function and internal logic thereof, and should not constitute any limitation on the implementation process of the embodiments of the present application.

It should be noted that those of ordinary skill in the art may understand that all or part of the steps implementing the foregoing embodiments may be implemented by hardware, and may also be performed by instructing the relevant hardware through the computer-readable instructions. The computer-readable instructions may be stored in a computer-readable storage medium, the storage medium may be a read-only memory, a magnetic disk or an optical disk, and so on.

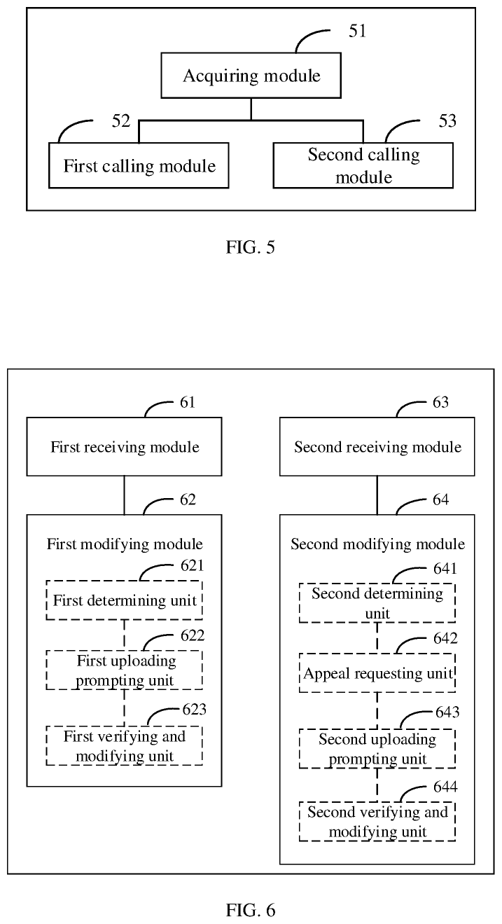

FIG. 5 shows a structure diagram of a device for modifying an account name according to an embodiment of the present application. For ease of description, only the part related to the embodiment of the present application is shown.

In this embodiment of the present application, the device for modifying an account name is used to implement the functions of the mobile terminal in the method for modifying an account name described in the embodiment of FIG. 1, and may be a software unit, a hardware unit, or a unit combining hardware and software built in a mobile terminal. The mobile terminal includes but is not limited to a smart phone.

Referring to FIG. 5, the device for modifying an account name comprises:

an acquiring module 51, configured to: in a process of a self-service claim settlement, generate an account name modification request according to a modified account name, and acquire a case status information corresponding to the self-service claim settlement;

a first calling module 52, configured to call a first modification interface to send the account name modification request to a server upon the condition that the case status information is that the self-service claim settlement is under review, such that the server modifies the account name of the self-service claim settlement according to the account name modification request, so as to prepare for a claim settlement transfer; and

a second calling module 53, configured to call a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiatess the transfer for the self-service claim settlement.

The device for modifying an account name mentioned above sends a modification request to the server through the two modification interfaces provided by the claim settlement system, such that the mobile terminal can support the self-modification of the account name, and the applicant may modify the account name on the mobile terminal on his own is realized, and the modification process of the account name is simplified.

FIG. 6 shows a structure diagram of a device for modifying an account name according to an embodiment of the present application. For ease of description, only the part related to the embodiment of the present application is shown.

In this embodiment of the present application, the device for modifying an account name is used to implement the functions of the sever in the method for modifying an account name described in the embodiment of FIG. 1, and may be a software unit, a hardware unit, or a unit combining hardware and software built in a server.

Referring to FIG. 6, the device for modifying an account name comprises:

a first receiving module 61, configured to: in a process of a self-service claim settlement, receive an account name modification request sent by a mobile terminal through a first modification interface;

a first modifying module 62, configured to modify the account name of the self-service claim settlement according to the account name modification request received by the first receiving module, so as to prepare for a claim settlement transfer;

a second receiving module 63, configured to receive the account name modification request sent by the mobile terminal through a second modification interface; and

a second modifying module 64, configured to modify the account name of the self-service claim settlement according to the account name modification request received by the second receiving module, and re-initiate the transfer for the self-service claim settlement.

Furthermore, the account name modification request further comprises an account number and an opening bank name input by an applicant.

Furthermore, the first modifying module 62 comprises:

a first determining unit 621, configured to determine whether the modified account name is a third-party account name, wherein the third-party account name is an account name of a third party other than the applicant or an associated insured of the applicant;

a first uploading prompting unit 622, configured to send an upload prompt message to the mobile terminal to inform the applicant to upload an account authorization information upon the condition that the modified account name is the third-party account name; and a first verifying and modifying unit 623, configured to acquire the account authorization information uploaded by the mobile terminal, trigger a verification process according to the account authorization information, and modify an original account name to the third-party account name after a review for the account authorization information is passed.

Furthermore, the second modifying module 64 comprises:

a second determining unit 641, configured to determine whether the modified account name is a third-party account name, wherein the third-party account name is an account name of a third party other than the applicant or an associated insured of the applicant;

an appeal requesting unit 642, configured to generate an appeal request according to the account name modification request and send the appeal request to a supervisor terminal upon the condition that the modified account name is the third-party account name;

a second uploading prompting unit 643, configured to send an upload prompt message to the mobile terminal to notify the applicant to upload an account authorization information upon the condition that an appeal success message returned by the supervisor terminal according to the appeal request is received; and

a second verifying and modifying unit 644, configured to acquire the account authorization information uploaded by the mobile terminal, trigger a verification process according to the account authorization information, and modify an original account name to the third-party account name after a review for the account authorization information is passed and initiate the transfer to the third party account name.

Optionally, the device for modifying further comprises:

a verifying module, configured to verify the account number and the opening bank name in the account name modification request through a predetermined verification rule; and upon the condition that the verification fails, acquiring an error type, and returning an error message to the mobile terminal.

The above device for modifying the account name modifies the account name of the self-service claim settlement based on the account name modification request sent by the first modification interface and the second modification interface, supports the self-modification function of the account name on the mobile terminal in the background, realizes that the applicant modifies the account name on the mobile terminal on his own; and adds the risk monitoring of the third-party account name, which improves the security of modifying the account name.

It should be noted that the terminal in the embodiments of the present application may be used to implement all technical solutions in the above method embodiments. Those skilled in the art can clearly understand that, for the convenience and conciseness of the description, only the division of the above functional units and modules are used as an example for illustration. In practical applications, the above functions may be completed by different functional units and modules according to needs, that is, the internal structure of the device is divided into different functional units or modules to complete all or some of the functions described above. Each functional unit and module in the embodiments may be integrated in one processing unit, or each unit may exist alone physically, or two or more units may be integrated in one unit. The integrated units mentioned above may be implemented in the form of hardware, and may also be implemented in the form of software. In addition, the specific names of the functional units and the modules are only for distinguishing each other and are not used to limit the protection scope of the present application. The specific working process of the units and modules mentioned above may be made reference to corresponding processes in the foregoing method embodiments, and details are not described herein again.

In the foregoing embodiments, the description of each embodiment has its own emphasis. For the part that is not described or described in detail in some embodiment, reference may be made to the relevant description of other embodiments.

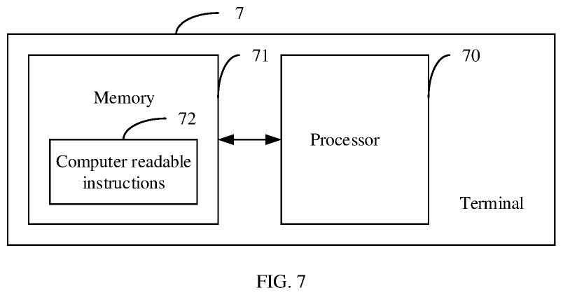

FIG. 7 is a schematic diagram of a terminal according to an embodiment of the present application. As shown in FIG. 7, the terminal 7 of this embodiment comprises: a processor 70, a memory 71 and computer readable instructions 72 stored in the memory 71 and operable on the processor 70. When the terminal is a mobile terminal, when the processor 70 executes the computer-readable instruction 72, the steps in the embodiments of the method for modifying an account name, such as steps S101, S102, and S104 shown in FIG. 1, are implemented; or when the processor 70 executes the computer-readable instruction 72, the function of each module/unit in the embodiment of the device for modifying the account name, such as the functions of the modules 51 to 53 shown in FIG. 5, is implemented. When the terminal is a sever, when the processor 70 executes the computer-readable instructions 72, the steps in the embodiments of the method for modifying an account name, such as steps S103 and S105 shown in FIG. 1, steps S201-S202 shown in FIG. 2, steps S301-S304 shown in FIG. 3, steps S401-S405 shown in FIG. 4, are implemented; or when the processor 70 executes the computer-readable instructions 72, the function of each module/unit in the embodiment of the device for modifying the account name, such as the functions of the modules 61 to 64 shown in FIG. 6, is implemented.

Exemplarily, the computer-readable instructions 72 may be divided into one or more modules/units, the one or more modules/units are stored in the memory 71 and executed by the processor 70 to complete this application. The one or more modules/units may be instruction sections of a series of computer readable instructions capable of performing a specific function, the instruction sections are configured to describe the execution process of the computer readable instructions 72 in the terminal 7. For example, when the terminal 7 is a mobile terminal, the computer-readable instructions 72 may be divided into an acquiring module, a first calling module, and a second calling module. Specific functions of the modules are as follows.

The acquiring module is configured to: in a process of a self-service claim settlement, generate an account name modification request according to a modified account name, and acquire a case status information corresponding to the self-service claim settlement.

The first calling module is configured to call a first modification interface to send the account name modification request to a server upon the condition that the case status information is that the self-service claim settlement is under review, such that the server modifies the account name of the self-service claim settlement according to the account name modification request, so as to prepare for a claim settlement transfer.

The second calling module is configured to call a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiate the transfer for the self-service claim settlement.

For example, when the terminal 7 is a sever, the computer-readable instructions 72 may be divided into a first receiving module, a first modifying module, a second receiving module, and a second modifying module. Specific functions of the modules are as follow.

A first receiving module is configured to: in a process of a self-service claim settlement, receive an account name modification request sent by a mobile terminal through a first modification interface.

A first modifying module is configured to modify the account name of the self-service claim settlement according to the account name modification request received by the first receiving module, so as to prepare for a claim settlement transfer.

A second receiving module is configured to receive the account name modification request sent by the mobile terminal through a second modification interface.

A second modifying module is configured to modify the account name of the self-service claim settlement according to the account name modification request received by the second receiving module, and re-initiate the transfer for the self-service claim settlement.

Furthermore, the first modifying module may be divided into:

a first determining unit, configured to determine whether the modified account name is a third-party account name, wherein the third-party account name is an account name of a third party other than the applicant or an associated insured of the applicant;

a first uploading prompting unit, configured to send an upload prompt message to the mobile terminal to inform the applicant to upload an account authorization information upon the condition that the modified account name is the third-party account name; and a first verifying and modifying unit, configured to acquire the account authorization information uploaded by the mobile terminal, trigger a verification process according to the account authorization information, and modify an original account name to the third-party account name after a review for the account authorization information is passed.

Furthermore, the second modifying module also may be divided into:

a second determining unit, configured to determine whether the modified account name is a third-party account name, wherein the third-party account name is an account name of a third party other than the applicant or an associated insured of the applicant;

an appeal requesting unit, configured to generate an appeal request according to the account name modification request and send the appeal request to a supervisor terminal upon the condition that the modified account name is the third-party account name;

a second uploading prompting unit, configured to send an upload prompt message to the mobile terminal to notify the applicant to upload an account authorization information upon the condition that an appeal success message returned by the supervisor terminal according to the appeal request is received; and

a second verifying and modifying unit configured to acquire the account authorization information uploaded by the mobile terminal, trigger a verification process according to the account authorization information, and modify an original account name to the third-party account name after a review for the account authorization information is passed and initiate the transfer to the third party account name.

The computer readable instructions 72 may also be divided into:

a verifying module, configured to verify the account number and the opening bank name in the account name modification request through a predetermined verification rule; and the verification fails acquiring an error type, and returning an error message to the mobile terminal.

The terminal may comprise but be not limited to, the processor 70 and the memory 71. Those skilled in the art can understand that FIG. 7 is merely an example of the terminal 7, does not constitute a limitation of the terminal 7, and may include more or less components than the illustration, or combine some components, or include different components, such as the terminal 7 may also include input and output devices, network access devices, buses, etc.

The processor 70 may be a central processing unit (CPU), or other general-purpose processors, digital signal processor (DSP), or Application Specific Integrated Circuit (ASIC), Field-Programmable Gate Array (FPGA) or other programmable logic device, discrete gate or transistor logic device, and discrete hardware component etc. The general-purpose processor may be a microprocessor or the processor may also be any conventional processor, etc. The processor is a control center of the terminal and connects various parts of the entire terminal using various interfaces and lines.

The memory 71 may be used for storing the computer readable instructions and/or modules. The processor runs or executes the computer readable instructions and/or modules stored in the memory and calls data stored in the memory to implement various functions of the terminal. The memory may mainly include a storage program area and a storage data area, wherein the storage program area may store an operating system, at least one application required by a function (such as a sound playing function, an image playing function, etc.) an so on; the storage data area may store data created based on the use of the terminal, etc. In addition, the memory may include a high-speed random access memory, and may also include a non-volatile memory, such as a hard disk, a memory, a plug-in hard disk, a smart media card (SMC), a secure digital card (SD), Flash Cards, at least one disk storage device, flash memory device, or other volatile solid state memory device.

Those of ordinary skill in the art may be aware that the exemplary units and algorithm steps described in conjunction with the embodiments disclosed herein can be implemented by an electronic hardware or a combination of computer software and electronic hardware. Whether these functions are implemented by the hardware or software depends on the specific application and design constraint conditions of the technical solution. The person skilled in the art may use different methods to implement the described functions for each specific application, but it should not be considered that the implementation goes beyond the scope of the present application.

In the embodiments provided by the present application, it should be understood that the disclosed device/terminal and method may be implemented by other means. For example, the apparatus/terminal apparatus embodiments described above are merely illustrative, for example, the division of the modules or units is just a kind of logical function division. In practice, there may be another division manner, for example multiple units or components may be combined or integrated into another system, or some features may be ignored or not performed. In addition, the illustrated or discussed mutual coupling or direct coupling or communication connection may be indirect coupling or communication connection through some interfaces, devices or units, and may be electrical, mechanical or other forms.

The units described as separate parts may or may not be physically separated, and the parts displayed as units may or may not be physical units, that is, may be positioned in one place, or may be distributed on multiple network units. Some or all of the units may be selected according to actual needs to achieve the purpose of the solution of this embodiment.

In addition, each functional unit in each embodiment of the present application may be integrated in one processing unit, or each unit may exist alone physically, or two or more units may be integrated in one unit. The above integrated unit may be implemented either in hardware or in software.

The integrated modules/units, if implemented in the form of software functional units and sold or used as independent products, may be stored in a computer-readable storage medium. Based on such understanding, all or part of the processes implementing the method of the above embodiments of the present application, may also be implemented by computer-readable instructions instructing the relevant hardware, and the computer-readable instructions may be stored in a computer-readable storage medium. When the computer-readable instructions are executed by the processor, the steps of the foregoing method embodiments may be implemented. Wherein, the computer-readable instructions includes computer-readable instructions code, and the computer-readable instructions code may be in the form of source code, object code, executable file or some intermediate and so on. The computer-readable storage medium may comprises: any entity or device capable of carrying the computer-readable instructions code, a recording medium, a U disk, a removable hard disk, a magnetic disk, an optical disk, a computer memory, a Read-Only Memory (ROM), a Random Access Memory (RAM), electrical carrier signals, telecommunications signals, and software distribution media, etc. It should be noted that the contents contained in the computer-readable storage medium may be appropriately increased or decreased according to the requirements of legislation and patent practice in the jurisdiction, for example, in some jurisdictions, according to legislation and patent practice, the computer-readable medium excludes electrical carrier signals and telecommunication signals.

The above embodiments are only used to illustrate the technical solutions of the present application, rather than limiting the same; although the present application has been described in detail with reference to the foregoing embodiments, those of ordinary skill in the art should understand that The technical solutions described in the foregoing embodiments may be modified or some of the technical features may be replaced equivalently; and these modifications or replacements do not deviate the nature of the corresponding technical solutions from the spirit and scope of the technical solutions in the embodiments of the present application and should be included in the scope of the present application.

1. A method for modifying an account name, comprising:
in a process of a self-service claim settlement, generating an account name modification request according to a modified account name, and acquiring a case status information corresponding to the self-service claim settlement, by the mobile terminal;
calling a first modification interface to send the account name modification request to a server by the mobile terminal upon the condition that the case status information is that the self-service claim settlement is under review;
receiving the account name modification request through the first modification interface and modifying the account name of the self-service claim settlement according to the account name modification request by the server, so as to prepare for a claim settlement transfer;
calling a second modification interface to send the account name modification request to the server by the mobile terminal upon the condition that the case status information is that the self-service claim settlement is in a settled state and the transfer for the self-service claim settlement fails due to incorrect account information; and
receiving the account name modification request through the second modification interface, modifying the account name of the self-service claim settlement according to the account name modification request, and re-initiating the transfer for the self-service claim settlement, by the server.

2. The method for modifying an account name according to claim 1, wherein the account name modification request further comprises an account number and an opening bank name input by an applicant.

3. The method for modifying an account name according to claim 2, wherein after the server receives the account name modification request through the first modification interface or the server receives the account name modification request through the second modification interface, the method further comprises:
verifying the account number and the opening bank name in the account name modification request by the sever through a predetermined verification rule; and
acquiring an error type and returning error information to the mobile terminal upon the condition that the verification fails.

4. The method for modifying an account name according to claim 1, wherein a step of modifying the account name of the self-service claim settlement according to the account name modification request so as to prepare for a claim settlement transfer comprises:
determining whether the modified account name is a third-party account name by the server, wherein the third-party account name is an account name of a third party other than the applicant or an associated insured of the applicant;
sending an upload prompt message to the mobile terminal to inform the applicant to upload an account authorization information by the sever upon the condition that the modified account name is the third-party account name; and
acquiring the account authorization information uploaded by the mobile terminal, triggering a verification process according to the account authorization information, and modifying an original account name to the third-party account name after a review for the account authorization information is passed, by the sever.

5. The method for modifying an account name according to claim 1, wherein a step of modifying the account name of the self-service claim settlement according to the account name modification request, and re-initiating the transfer for the self-service claim settlement comprises:
determining whether the modified account name is a third-party account name by the server, wherein the third-party account name is an account name of a third party other than the applicant or an associated insured of the applicant;
generating an appeal request according to the account name modification request and sending the appeal request to a supervisor terminal by the server upon the condition that the modified account name is the third-party account name;
sending an upload prompt message to the mobile terminal by the server to notify the applicant to upload an account authorization information upon the condition that an appeal success message returned by the supervisor terminal according to the appeal request is received; and
acquiring the account authorization information uploaded by the mobile terminal, triggering a verification process according to the account authorization information, and modifying an original account name to the third-party account name after a review for the account authorization information is passed and initiating the transfer to the third party account name, by the sever.

6-15. (canceled)

16. A terminal comprising a memory, a processor, and computer readable instructions stored in the memory and operable on the processor, wherein when the processor executes the computer readable instructions, the following steps are implemented:
in a process of a self-service claim settlement, generating an account name modification request according to a modified account name, and acquiring a case status information corresponding to the self-service claim settlement;
calling a first modification interface to send the account name modification request to a server upon the condition that the case status information is that the self-service claim settlement is under review, such that the server modifies the account name of the self-service claim settlement according to the account name modification request, so as to prepare for a claim settlement transfer; and
calling a second modification interface to send the account name modification request to the server upon the condition that the case status information is that the self-service claim settlement is in a settled state and the transfer for the self-service claim settlement fails due to incorrect account information, such that the sever modifies the account name of the self-service claim settlement according to the account name modification request, and re-initiates the transfer for the self-service claim settlement.

17. A terminal comprising a memory, a processor, and computer readable instructions stored in the memory and operable on the processor, wherein when the processor executes the computer readable instructions, the following steps are implemented:
in a process of a self-service claim settlement, receiving an account name modification request sent through a first modification interface;
modifying the account name of the self-service claim settlement according to the account name modification request received by the first modification interface, so as to prepare for a claim settlement transfer;
receiving the account name modification request sent by the mobile terminal through a second modification interface; and
modifying the account name of the self-service claim settlement according to the account name modification request received by the second modification interface, and re-initiating the transfer for the self-service claim settlement.

18. The terminal according to claim 17, wherein modifying the account name of the self-service claim settlement according to the account name modification request received by the first modification interface, so as to prepare for a claim settlement transfer comprises:
determining whether the modified account name is a third-party account name, wherein the third-party account name is an account name of a third party other than the applicant or an associated insured of the applicant;
sending an upload prompt message to the mobile terminal to inform the applicant to upload an account authorization information upon the condition that the modified account name is the third-party account name; and
acquiring the account authorization information uploaded by the mobile terminal, triggering a verification process according to the account authorization information, and modifying an original account name to the third-party account name after a review for the account authorization information is passed.

19. The terminal according to claim 17, wherein modifying the account name of the self-service claim settlement according to the account name modification request received by the second modification interface, and re-initiating the transfer for the self-service claim settlement comprises:
determining whether the modified account name is a third-party account name, wherein the third-party account name is an account name of a third party other than the applicant or an associated insured of the applicant;
generating an appeal request according to the account name modification request and sending the appeal request to a supervisor terminal upon the condition that the modified account name is the third-party account name;
sending an upload prompt message to the mobile terminal to notify the applicant to upload an account authorization information upon the condition that an appeal success message returned by the supervisor terminal according to the appeal request is received; and
acquiring the account authorization information uploaded by the mobile terminal, triggering a verification process according to the account authorization information, and modifying an original account name to the third-party account name after a review for the account authorization information is passed and initiating the transfer to the third party account name.

20. The terminal according to claim 17, wherein when the processor executes the computer readable instructions, the following step is implemented:
verifying the account number and the opening bank name in the account name modification request through a predetermined verification rule; and upon the condition that the verification fails, acquiring an error type, and returning an error message to the mobile terminal.
